(19) United States
(12) Patent Application Publication
(10) Pub. No.: US 2025/0269289 A1
(43) Pub. Date: Aug. 28, 2025

(54) Game Tracking and Gamification System

(71) Applicants: Megan Charity, Charlotte, NC (US); Barrett Worthington, Charlotte, NC (US)

(72) Inventors: Megan Charity, Charlotte, NC (US); Barrett Worthington, Charlotte, NC (US)

(21) Appl. No.: 18/590,477

(22) Filed: Feb. 28, 2024

(51) Int. Cl. A63F 13/86; A63F 13/655

(52) U.S. Cl. CPC A63F 13/86; A63F 13/655

(57) ABSTRACT

A game tracking system is presented having gamification features and functionalities that enable system scaling and enhancement for various game structures and directed content distribution continuously and for the duration of gaming activity. Distinct game modules are seamlessly enabled through a user interface to integrate with a base game module used to determine the fundamental game outcomes from information received from the game tracking system. The game modules affect play and scoring through new game rules while maintaining use of the base game module and using the data derived therefrom in application to the new game rules. In accordance with the distinct game modules, content distribution is directionally applied to a series of display devices in accordance with tracked game outcomes, game results and other conditions. A number of distinct game modules can be selected having a distinct set of game rules with the accompanying content distribution varying with each.

### FIELD OF THE INVENTION

The present invention relates to an enhanced game tracking system and, more particularly, to the enduring, dynamic gamification of a game tracking system. A particular focus of the system described herein is to use the underlying technology associated with the tracking of position and trajectory of game objects to enable players of sporting activities to participate in certain fun, social and competitive activities associated with a game within a game (i.e., gamification). The system further enables seamless transition between different gamification formats while maintaining unmodified use of the underlying tracking technology, and further to view indicia of such activities in a coordinated manner and in accordance with the rules of the game within a game.

### BACKGROUND

With the advent of computer vision technology, a number of tracking systems have been developed for use in game play. Computer vision is a multi-discipline technology that involves information and data generation derived from digital images or videos taken from high resolution IP cameras. Using certain applications within the field of computer vision, digital cameras that are positioned about an area used for the play of a game (e.g., a field or a court) transmit images to certain data processing units linked to the cameras which, relying on certain pre-programmed algorithms to assess the data, determine the position of game objects relative to field or court parameters and static elements. A number of systems have been developed in recent years to make use of this technology in sports. The technology provides automation and precision to what once was a manual endeavor that relied on individual human eyesight, judgement and manual tracking of the game. One such early system based on computer vision was developed by Hawk-Eye Innovations.

The Hawk-Eye system was one of the first computer vision-based systems developed in or around 2001 for tracking the position of tennis balls and enabling game play “calls” based on the computed image data. It has since been deployed for use in a number of different sporting games. The system uses multiple high-frame rate cameras to triangulate the three-dimensional position of a moving ball and can similarly be used for player tracking. The system is able to discern line calls in tennis, goals in soccer, and make other calls in the same or other games using the tracking of computer vision and its ability to determine game object positioning. The system generates a graphic display depicting the game objects' positions and trajectories relative to the game boundaries and other objects so that the viewer can see, for instance, a depiction of the tennis ball going out or staying in, or a soccer ball crossing or not crossing the net line.

There are other commercialized systems that utilize computer vision in sports play. Some may adapt proprietary technologies into their systems to enhance the basic aspects of computer vision technology. For instance, patent Ser. No. 10/143,907 by Gentil includes a single fixed location camera that identifies object state conditions that effectively transform a 3D object tracking problem that otherwise would require a multi-camera setup in to a 2D planar problem that can be solved by relying on video frames generated by a single fixed-location camera to make accurate line calls.

There are many other branded systems in the market, all utilizing computer vision technology. Additional technologies may be included with some to enhance the system. But all of these systems are dedicated to the game they serve. There is no variation. A hardened set of rules exist and the system works within these rules and only those rules. It serves its purpose well for the game of tennis if deployed for tennis, soccer if deployed for soccer, or the specific game for which it is being used. But there is a certain market, a certain venue and a certain type of player that desires more than just a tracking system for a specific, basic game with unalterable rules of play that offers little more than determining general outcomes of such basic game.

### SUMMARY

The present invention is directed to the gamification of a game tracking and scoring system that provides the features and functions of tracking game play and game outcomes while enabling players to rapidly and seamlessly modify or change the game they wish to play and the output aspects associated therewith while maintaining the fundamental contours of base game fundamentals derived from the game tracking and scoring system. Therefore, the fundamental aspects that exist in a base game remain, such as, for a court-based game, when a ball falls “in” or “out” in accordance with game boundaries, whether a ball has been stopped by the net, ensuring players are positioned at proper locations of the court during play, among other things, while the higher level features are incorporated to modify the base game. The modified game derived from the base game includes additional or modified features and activities that create a fun, social and unique experience for the players. The system enables the experience on a continuous basis and is dynamically responsive to the random, unpredictive events associated with game activities.

It is therefore an object of the invention to provide a system based on computer vision technology that, used in conjunction with heuristic statistical algorithms, tracks game objects during the play of a game and determines their positions relative to other objects where game outcomes derived from such are applied to a set of basic game rules to obtain certain basic outcome data. Game modules having a different set of game rules and associated with certain game outputs can be seamlessly integrated and layered atop the base game module that is the module used primarily for assessing the fundamental outcome data received from the tracking and position determining portion of the system.

Another object of the invention enables the player to select the game module to be layered atop the base game module. A series of gamified games may be offered to the player for selection and through a user interface, the player may select any of them. The game module is then seamlessly integrated with the base game module to establish the set of rules associated with that game module and discard or modify those of the base game module or previously implemented game module, which would then be decoupled from the base game module. Additionally, fundamental data output associated with the base game module is used in accordance with the rules of play associated with the newly selected gamified game module and the computer-based instructions associated therewith.

It is yet another object of the invention that there be outputs associated with the selected gamified game module that comprise various content for delivery to display devices. The content may comprise such things as scoreboards, countdown clocks, leaderboards, animated graphic displays upon certain specified outcomes, advertisements, displays of player positions and player activity, replays associated with game play, messaging, and any other form of content. The content can be displayed on a number of display screens located throughout a venue. The display devices, which can be any form of computerized device having a monitor, can be situated in a lounge area, a bar location, near the court of play or other courts, at the entrance. They can also be personal mobile devices, such as smartphones or tablets, and personal computers that are linked to the system through an ISP link. In accordance with the rules of the selected game module, content is directed to the various display screens upon a condition or trigger associated with the activities of the selected game and such content may differ depending on the display screen to which it is directed. Therefore, in one part of the venue a leader board with certain messaging could be displayed on the display device located there, while at another location of the venue a graphic may be provided showing player activity and where they are to be respectively positioned about the court. All conditions and triggers are established within the game module of the selected game as is the content to be displayed and the display devices upon which the content is to be displayed.

It is another object of the invention that the gaming aspects of the selected game maintain the features of the prior objects in a continuous, uninterrupted, and dynamic manner. The gaming aspects of the selected gamified game, including the game rules of the selected gamified game module and the delivery of directed content module displays are provided continuously throughout the duration of the gaming activity. The timing of delivery and the specific content delivered is dynamically determined based on data received from game activity and in accordance with the rules of the gamified game.

It is yet another object of the invention that each player be individually established through a computer-based registration process. A record is then established in a database of the system for each of the registered players. As the players sign up to play a gamified game, they are identified by the system. Their positions are tracked during the game as are their activities including game outcomes such as “clean winners” in a pickleball game, “aces” in a tennis match, the length of a volley, average length of all volleys; and game results such as points scored, points lost, winning games, losing games, and stored in memory. During play or at any point prior to, during or after game activity has ceased, statistics and metrics associated with the player are posted in one of the content displays at one or more of the display devices upon the satisfaction of a certain condition or trigger. The registration process can also enable the forming of teams whereby statistics and metrics associated with such team can be stored in memory and also displayed on one or more of the display devices upon satisfaction of a certain condition or trigger.

It was said that the intent of the present invention was to create a fun, social and unique experience for players that departs from the relatively mundane aspects of a basic game tracking system designed merely to support through technical means game outcome results. This is accomplished through all of the objects of the invention noted, individually and in combination. Individual players can be identified by the game tracking and gamification system as individuals or as a combination of individuals of a team. A game can be seamlessly selected for play and the individual or team can compete against other individuals or teams. The game tracking portion of the system identifies the players and other game objects and for game outcomes and delivers such data to the game module where it is converted to game results and individual and team statistics, in accordance with the game rules. The system is in communication with a number of display devices and upon certain conditions associated with game outcomes and game results delivers specified content in accordance with the instructions of the gamified game module, to one or more of the display devices as directed by such instructions.

### BRIEF DESCRIPTION OF THE DRAWINGS

These and other features, aspects, and advantages of the present invention will become better understood with regard to the following description, appended claims, and the accompanying drawings:

FIG. 1 illustrates some of the front end features of the game tracking and gamification system used with a pickleball court.

FIG. 2 illustrates an embodiment of the front end features of the game tracking and gamification system in a multi-pickleball court setting.

FIG. 3 is a schematic layout of the back end components and modules associated with the game tracking and gamification system.

FIG. 4 shows the initial operational output of the system in accordance with event-dependent triggers.

FIG. 4A shows certain operational output of the system in accordance with event-dependent triggers for a game embodiment.

FIG. 4B shows certain operational output of the system in accordance with event-dependent triggers for a second game embodiment.

### DETAILED DESCRIPTION

In the following description, certain details existing in the prior art may be set forth in order to provide a more thorough description and understanding of the present invention. It will become apparent, however, to one skilled in the art, that the invention may be practiced without some or any of such detail and that it may also be practiced in association with other prior art embodiments not described herein. In other instances, well-known details of the prior art that are otherwise known by those skilled in the art may be left out so as not to obscure the invention and so as not to include superfluous words in the description.

The present invention is directed to a game tracking and gamification system that enables the system to scale game play for various gaming structures and the game rules associated therewith. The system is envisioned for use with the game of pickleball but has application with other game forms. The system monitors game activity, including ball trajectory, ball positioning and player movements, through a network of GigE cameras or other digital IP cameras. The IP cameras receive control data and send image data back through an IP-based ethernet network. Real-time visualization assesses such activity relative to static objects such as court boundaries and the net, which are pre-programmed elements known to the system, and the rules of the game using computer vision techniques and applications, including triangulation, and further including heuristic-statistical techniques and applications that construct trajectories of moving objects and predict their positions using data derived from computer vision. Based on this real-time visualization, game activity and game status are displayed on multiple display devices.

The system is not limited to the strict assessment of one set of game rules. For a given base game application, a new game variant can be seamlessly implemented at both the user interface (UI) and within the back end game code without the need for extensive reprogramming. Aspects of the base game will always remain, such as computing game object trajectories, determining when a game object strikes the ground, when a game object strikes a racquet, when service is to occur as in most any racquet/court game such as pickleball or tennis and service position, and determining game state. This is provided through the processing modules that track the positions and trajectories of game objects while in continuous, real-time communication with a base game module for determining game state. However, variant game rules can be easily couple to and decoupled from the base game module through gamified game modules and new or variant game rules placed in communication with the processing modules along with the base module for dynamic adjustment and seamless integration of such new or variant game and ease in scalability of the system.

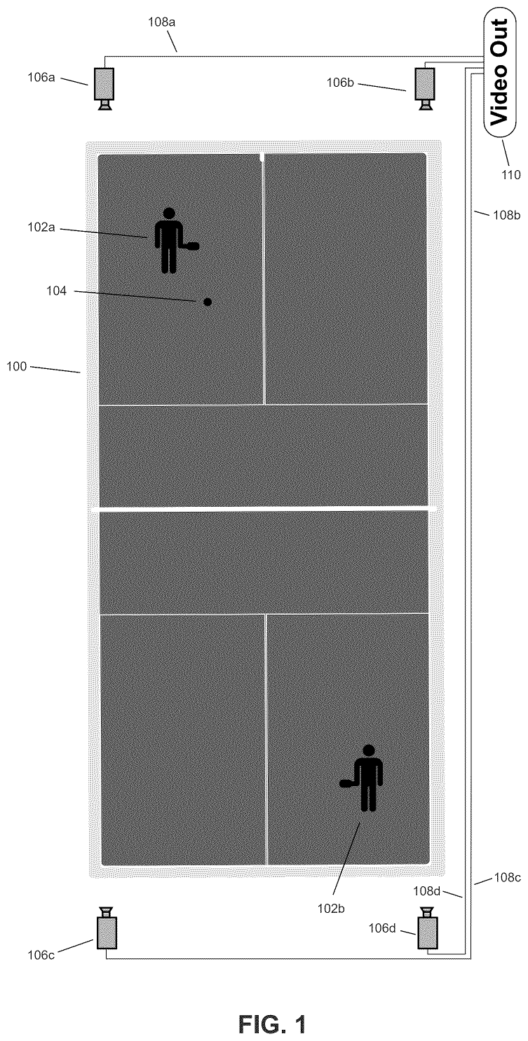

FIG. 1 is an image of a pickleball court 100. Though the invention can embody different games and court configurations, it will be discussed in the context of the game of pickleball and a pickleball court. The system need only be modified to accommodate the different configuration of the court, the dynamic aspects of game activity for position and trajectory determinations (i.e., how the physical behavior of game objects), the rules of play and the gamification aspects particular to the gamified game and game modules included. The basic construct of the system remains.

In FIG. 1, there are shown two players 102a and 102b, although there could be four if playing doubles, and ball 104. The game tracking and gamification system tracks the play of the game and enables the selection of the game or gamified game to be played, among other things. The game tracking and gamification system includes at least two cameras to enable computer vision triangulation. However, in the preferred embodiment the system includes four cameras 106a, 106b, 106c, 106d and may include more. Cameras 106a, 106b, 106c, 106d are IP cameras such as GigE Vision cameras, which can be identified by a unique IP address and send out image data through Ethernet networks. The GigE camera is designed to capture fast moving game objects with minimal blur due to short exposure times. These types of IP cameras provide framing of short and accurately repetitive duration enabling precision tracking through triangulation to determine object positioning. GigE Vision cameras feature technology based upon the GigE Vision Standard, which leverages Gigabit Ethernet technology, including a hardware interface, communications protocol and standardized control registers. They can achieve data transfer rates of up to 100 MB/s and can accommodate cable lengths of up to 100 meters.

The image data is transferred through Ethernet cables 108a, 108b, 108c, 108d and other ethernet networking hardware sufficient to ensure video signals from the IP cameras are seamlessly and synchronously transmitted through an Ethernet switch to a processing unit. Transfer rates of at least 1 GB are required for adequate operation. The image data is transferred out at 110 from pickleball court 100 for processing and subsequent transmission of output from the backend system modules.

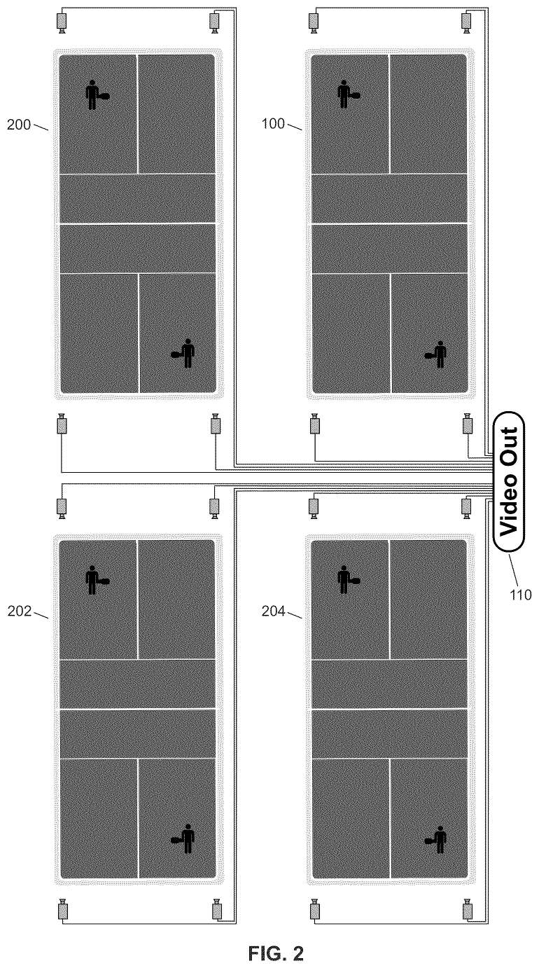

It is noted that in an expanded embodiment of the invention, multiple game tracking systems with a gamification layer may be deployed for use with multiple courts 100, 200, 202, 204. The various systems can be configured for communication between and among themselves. This form of embodiment, which is generally depicted in FIG. 2, is used for tournament play or gamification aspects that involve interactive play among multiple courts. Video out 110 is shown at one location but may alternatively be directed at separate locations per court 100, 200, 202, 204. As will be shown, the video stream is directed to an Ethernet switch which can be one to accommodate all courts 100, 200, 202, 204, in this multiple court embodiment, or each system can stream video to a separate Ethernet switch where it will be transmitted, accordingly, to applicable system modules for processing.

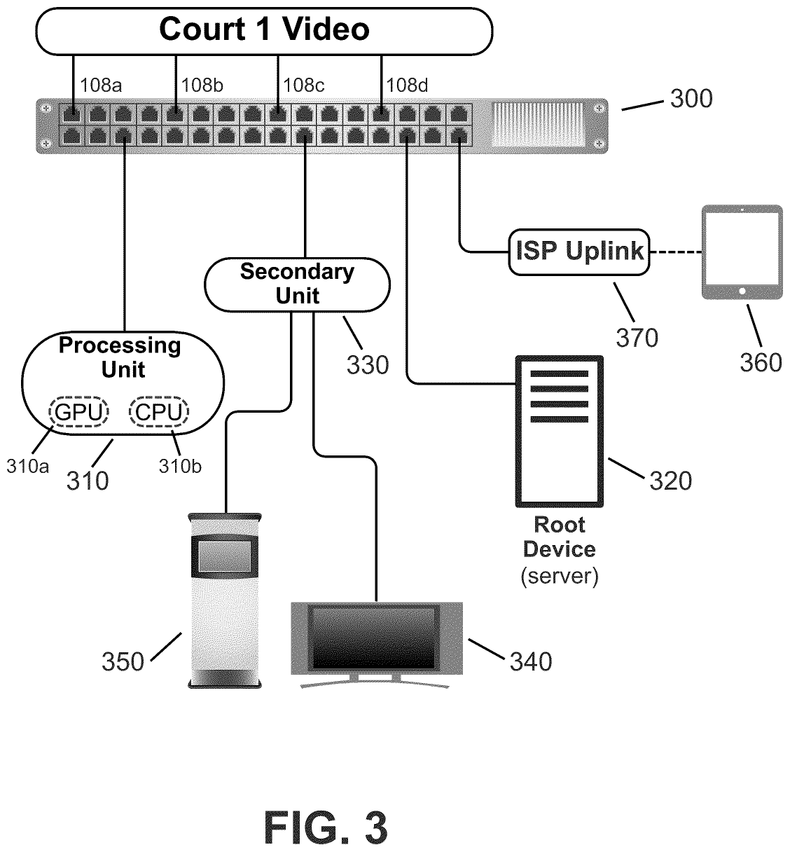

FIG. 3 is a schematic of the game tracking and gamification system from the point of receiving the video image data from IP cameras 106a, 106b, 106c and 106d of pickleball court 100. The video stream from each IP camera is transmitted to Ethernet switch 300 through Ethernet cable 108a, 108b, 108c and 108d. Ethernet networking hardware is used to ensure the video stream from IP cameras 106a, 106b, 106c and 106d are seamlessly and synchronously transmitted through to processing unit 310. To ensure optimum data transfer rates, cables 108a, 108b, 108c and 108d of at least Cat 6 capability are desired. However, any high rate transfer video cable may be used such as coaxial cable or fiber optic cable coupled with an applicable adapter for use with the Ethernet-established local area network (LAN).

Ethernet switch 300 possesses at least two 10 Gb ports to enable transfer of data at a rate of 10 gigabits per second and four ports of at least 1 Gb to enable transfer of data at rates of up to 1 gigabit of data per second. Ethernet switch 300 further includes an Internet uplink to enable communications outside the local area network that is core to the game tracking and gamification system. Though the example embodiment exhibited in FIG. 3 displays a single Ethernet switch, in some embodiments of the system, multiple interconnected switches may be required when the video signal must travel beyond typical Ethernet limitations. Additionally, as in the embodiment of FIG. 2, multiple Ethernet switches can be used with multiple game tracking and gamification systems.

The video signal emanating from IP cameras 106a, 106b, 106c and 106d are passed through cables 108a, 108b, 108c, and 108d, respectively, through Ethernet switch 300 to processing unit 310. Processing unit 310 includes both a combined graphic processing unit (GPU) 310a and computational unit (CPU) 310b which reads and processes the real-time streaming image data received from IP cameras 106a, 106b, 106c and 106d. Graphic processing is performed through a 3D software module that uses triangulation methods in computer vision. The image frames from each frame of the networked IP cameras are synchronously received and those of similar timestamp are analyzed by GPU 310a for triangulated positioning of game objects. Based on the known placement of each camera about the game court's boundaries, the 3D software module is thus able to compute the positions of the various objects within each of the IP camera frames that achieved an image during the given timestamp. The IP cameras are each assigned an IP address to indicate the frame source.

Processing unit 310 and GPU 310a detects all moving objects within the assessed frames despite some objects not necessarily being relevant to the game. Heuristic-statistical models are constructed that further enable the processing unit 310 with processing from CPU 310b to better define location and path of movement of game objects—not just objects within the frame—and to locate such when the networked IP cameras are unable to provide real-time image data. These models establish certain trajectories that known game objects will follow. These trajectories are based on the known movement of these relevant game objects, such as the ball 104 in the game of pickleball. Object movements detected by GPU 310a and CPU 310b of processing unit 310 that do not comport with one or more of the trajectories are filtered out based on the programming of the heuristic models and ignored. For example, in the game of pickleball, a serve will emanate from a certain position on the court. The system recognizes this and identifies the moving object from such position as a relevant game object. However, because the system is programmed to identify the trajectory of a pickleball ball in flight given its speed, acceleration, angle of trajectory, rates of descent due to gravity, and size, among other factors, if the object had been a soccer ball, a beer can or a piece of paper, the object would not behave in accordance with any of the constructed trajectories, would be filtered out and therefore discarded and ignored as a nonrelevant object.

Computational unit 310b processes data in conjunction with the GPU 310a. Constant polling extracts data of GPU 310a for use by computation unit 310a. GPU 310a and CPU 310b can be a combined graphic processor and central processing unit such as the Nvidia Jetson; preferably the Jetson Orin AGX model. However, the system is capable of satisfactory performance based on the Jetson Xavier AGX or model of similar capabilities. Each combines graphic processing capabilities for computer vision positional tracking and computational processing for application of heuristic algorithms for object determination and trajectory prediction.

Processing unit 310 is programmed to actively identify the trajectories of relevant game objects only during live play of the game. Therefore, once live play is concluded, as detected by the rules indicated within the game module of the system, either the base game module or the gamified/layered game module that includes new rules for a new or gamified game, identification of objects is paused until such time as live play begins once more. In the game of pickleball, the serve is detectable by the system due to the origination of movement of a relevant game object from a relative position. Such activity detected by the system initiates processing unit 310 and the relevant game objects are then tracked. A failure to allow one bounce during the first full volley or a detection of two bounces of the ball, stepping into the “kitchen”, a ball bounce outside the boundaries of the court, or a failure to return the ball to the other side of the court, among potentially other actions, will cause the processing unit to pause object detection. The game module software is programmed to read the inputs from the processing module to determine that once inputs are received indicating a next action at a specific location on the court, the game tracking and object detection will re-initiate with the game module. The game module is programmed to know the rules of the game, to receive input of data, and to provide output, accordingly, to enable monitoring and reading of game activity and game activity results. This will be discussed in more detail, below.

As mentioned above, processing unit 310b relies on heuristic-statistical algorithms that are programmed within the 3D software module of processing unit 310 to assist in identifying the positioning and to construct trajectories of game objects. Game objects can be obscured during play due to the positioning of players, racquets, the net or other objects on or around the court. Additionally, at certain angles, the cameras may be positioned such that the relevant game objects are only visible to one. At least two cameras and therefore two video frames are needed for the computer vision portion of the processing unit to triangulate position. Optimally, the system includes at least four cameras for optimum coverage. Algorithms established based on these heuristic techniques predict the position of game objects when such conditions arise. The algorithms are established based on an iterative process considering factors such as speed, acceleration, gravity and drag. Equations of motion as determined for a pickleball ball (see www.pickleballscience.org) are embodied within the code-based rules of this predictive software module and, with the use of position data from the GPU, the trajectory of the ball and its time-dependent position is determined with great accuracy.

The game tracking and gamification system includes root device 320. Root device 320 is a server that maintains much of the system logic. Root device 320 continuously polls and is thus in constant communication with processing unit 310. Root device 320 receives the object data, positioning and trajectory data from processing unit 310 and sends back control data. Included in root device 320 is the base game module and a number of gamified game modules, each of which manage game play. The base game module is programmed to interpret game fundamentals. Constant data reporting from processing unit 310 to root device 320 and the base game module, in particular, regarding the positioning of game objects triggers game play output such as serves, net crossings, ball position, player position, ground hits, net hits that prevent ball trajectory to the opposing side of the court, and outs. Additionally, clear winners and the like can be detected. A “clear winner” in pickleball is a shot that lands in the opponent's side of the court and is not touched by the opposing player before it bounces twice or goes out of bounds. The shot is hit with enough pace and precision that the opponent is unable to make a return or even get their pickleball racquet to make contact with the ball. This data in turn enables the game modules to assign points scored, assess the parameter for service such as where next service is to be made and by whom, and provide any manner of associated game play output and recordation of statistical information. The game module of the root device 320 sends control data to processing unit 310 on when to initiate and terminate tracking and from which court position play should initiate.

Root device 310 is the central system component. It contains the bulk of the system programming, including the base game module and various gamified game modules that can be coupled or decoupled to the base game module to modify or add variation to the base game on the fly. Though the processing unit embodies the technological complexity in runtime processing of large volumes of data received from the IP cameras and performing all of the tracking, it is root device 310 that is the programming brains.

Based on game state, control data is also transmitted to secondary unit 330 from root device 320. Secondary unit 330 is managed by root device 320. Secondary unit 330 includes a module that transmits visualization data to various display screens based on instructions of the game module and root device 320 which are based on the state of game activity. In the example embodiment of FIG. 3, there are three display screens; monitor 340, kiosk 350 and tablet 360. There can be any number of display screens. Monitor 340 and kiosk 350 linked to the system through HDMI, DisplayPort or other high rate video transmission interface. Advance video coding H.264 or similar compression standard may be employed to help enable data transfer. An ISP uplink 370 is included to enable TCP/IP protocol-based communication for Internet and Wi-Fi linkage. Tablet 360 is linked via TCP/IP to enable mobility of use. Any number of other devices can be similarly linked through ISP uplink 370 given TCP/IP communications and access to the system. Therefore, remote access is available and the system need not be accessed within the venue.

The game module of root device 320 instructs secondary unit 330 to deliver content to viewers at addressable devices having video screens that are located throughout the venue and, if applicable, to additional devices linked via ISP uplink 370. Various standard visualization tools, as known in art, are used to display the objects in a directed manner. Depending on the given instructions, one such content display may be transmitted to monitor 340, another content display to kiosk 350, another to tablet 360, and yet another to a remote user on a personal computer or mobile device not shown that is in communication with the game tracking and gamification system. Each of such devices possesses an address enabling directed content transmission to such, as dictated by the rules of the game module and as carried out by secondary unit 330. Alternatively, one or another of the display devices may receive no new directed content for display and may maintain a display previously transmitted. Thus, at any given time, the display screens of each of the devices in communication with the system can display any or all of the same content as another device, different content from one or more of the other display devices, or no content at all; all dictated by the programmed instructions of the game module; be it the based game module or gamified game module.

Some content displays are constructed in accordance with the current game state and the programmed instructions of the game module. Constructed content displays use previously created content combined with game play outcome data such as winning points, game fouls, out-of-bounds occurrences, clean winners, the identification of the server, the present score, etc. This game play outcome data can be one of the content displays that gets displayed at one or more designated video screens at a given point in time. Such game outcome data is also stored in various databases for later retrieval and use in other content displays such as leaderboards, player and team statistics and other metrics.

Static content is also distributed dependent on the current game state and the programmed instructions of the game module. These content modules do not need to be combined with game outcome data or any external data. Such content modules might be advertisements, logos, or any manner of content not requiring inclusion of real-time game outcome data or any storable to complete the display.

Thus, at any given time during gameplay, between gameplay states, or even when there is no active gameplay (i.e., a game is neither active nor in between points—it is prior to the initiation or subsequent to the completion of a game), instructions from the game module in root device 320 can be dynamically delivered to secondary unit 330 in accordance with trigger events associated with game activity. The instructions are read and secondary unit 330, in accordance with the instructions, transmits assigned display content to one or more of display devices 340, 350, 360 and any other devices in communication with the system through ISP link 370 and the given game. The content displayed can be any module of content transmitted to any device, in accordance with pre-programmed instructions, whether the content is stored, static content as described, dynamically modified content based on real-time game outcome data associated with the game activity, or modified content based on stored data. For instance, prior to initiation of game play, tablet 360 is instructed to display a user interface for registration of court time. It could be preceded by a display of a system logo that, upon input, displays the user interface. It could include a payment application that allows a user to pay for court time. It could further provide a menu for selection of the type of gamified game a player or group of players may wish to participate in. If a player maintains an account with the system, identification indicia such as an account name and personal identification number may be entered to access the system. While tablet 360 displays these or other types of display screens, monitor 340 and kiosk 350 display screens are receiving instructions from root device 320 to display the system logo on screen until such time as a new game is activated at the user interface of tablet 360 or other device in communication with the system through ISP uplink 370.

As earlier indicated, another device could be a remote personal computer or mobile device. A software-based application or app, the term commonly used, that is used in association with the game tracking and gamification system can be downloaded to such computer or mobile device. From the computer or mobile device, the user can register with the system through the app interface to gain secure access using the systems established registration protocols or, if previously established, the user can log in to the system with username and password or other secure access indicia granted through the previous registration process. Once linked to and in communication with the system, the computer or mobile device is another display device capable of receiving directed content displays prior to, during, and after game play activity. Additionally, through the app, individual or team statistics, metrics and histories stored in the system database can be accessed and displayed on the computer or mobile device display screen. Leaderboard information and histories can be accessed to see the best, worst, average performances for individuals or teams for any given day, week, month, or for all time, as made available by system programming. Displays showing use times, numbers of games played, types of games played by individuals or teams can also be created and made available for access and display. Any information programmed for storage in the system database and retrievable through app programming parameters can be made available to a user of the app through the user interface, including information commonly accessible within apps such as personal identification information, security information, display options, among other things. Personal and team goals can also be established such as time spent in play, the number of games played, the number of games won, the teams played, individuals played, etc., and the system can be made to track ongoing progress and if or when such goals are met. All of these metrics and statistics can be made available and accessible through the user interface of the app.

As players register to play, whether from tablet 360 or through the app residing on a user's computer or mobile device, instructions from root device 320 to secondary unit 330 might cause a signal to be transmitted to monitor 340, which may be positioned within a room, lounge or other location for public or semi-public viewing, to display something other than the system logo. For instance, the display could indicate that a game is being assembled for the given court in which the system is associated. As the players register, the player's name or handle (i.e., a pseudonym) could be shown along with an avatar of the player so that they are graphically depicted. The handle and avatar can be displayed at a respective position from where they are intended to initiate action once the game commences so that they can be tagged and then individually tracked by the system. After registration, instructions can be provided to remove the system logo from the screen of kiosk 350 and for processing unit 310 to initiate tracking. As the players begin to assemble on the court, additional instructions to secondary unit 330 can cause a display at kiosk 350 of the players assembling on court or a graphic showing each player's avatar and handle at the respective positions from where they are to begin action. If shown assembling, the display could be animatronic imaging or a live feed could be provided from one or more of the IP cameras situated about the court where the game is to be played. With the IP cameras and the processing units, player location data can be determined and animatronic figures used to portray their locations. These types of directed displays would be essentially consistent and repetitively repeat each time players register (save the avatars and handles of the players). However, as will be shown, the directed displays can be variable and less predictive during game play and where the content displays transmitted to the various display devices can depend on game outcome or as randomly generated from a plurality of available content display modules.

In addition to displays at the monitor and kiosk, computer and mobile devices logged on and in secure communication with the system can be provided an option to link to the a given game. Once attached to that game, the personal computer or mobile device is detected as another display device for directed delivery of content. In accordance with the programming of the game module associated with the selected gamified game, the received content can be the same as that received by any of tablet 360, kiosk 350, monitor 340, or, through determination that the address of the computer or mobile device is a display device external to the venue, it could be uniquely delivered content.

Processing unit 310 detects the initiation of the game through relevant tracking activity occurring at the initial serving position. Therefore, the positioning and motion of the ball and player are detected by processing unit 310 which reads that input data as being associated with game service. At this point, a condition is triggered sending instructions once again to secondary unit 330 to send different content displays to the various video display screens of the system. For instance, a scorecard graphic could be displayed on monitor 340. Individuals not participating in the game might view the score and other aspects, such as clean winners, within a non-court-based location. A similar display might be sent to kiosk 350 for the players to see. The instructions can additionally indicate to the players which player is to serve and from which service court to ensure they are in proper positions for tagging and tracking along with other information that may be pertinent to the players but not to the non-playing viewers who are watching the display indicia at monitor 340 or other device apart from the court. Tablet 360 may be instructed to resume display of the system logo and may be enabled for further registration by players who wish to utilize the court after the current game is concluded. Other features might be displayed including selectable options to access various information, including metrics and histories of players and teams, time remaining on current game, tutorial videos showing how the game is played, instructions on game play, and access to a player accounts, among other things. It should be apparent that although certain display devices are referenced herein for certain directed delivery of content, other display devices can be programmed to receive the same. Thus, for instance, personal computers and mobile devices linked to the system and associated with the applicable game may receive some, all or none of the same content as that received by tablet 360 or may receive unique content intended only for such devices.

During game play various content display modules are also sent to the various display devices. These can include in addition to content previously mentioned countdown clocks that display the time left until start of play, the time left until the end of play, the time until the next point must be served, and the time left for available court use. Additionally, replays of previously played points can be transmitted after conclusion of a point and prior to next serve. Advertisements, notifications, graphic animations, as well as scores, leaderboards, player and team metrics, can all be transmitted to the display devices as determined by the rules of the game module. The timing of certain transmissions to the display screens are coordinated to correspond with the events of game play, as determined by the game module of root device 310 in conjunction with the data fed to root device 310 by processing unit 310 and as delivered to the secondary unit 330. The above examples are just exemplative of the types of displays. Any form of display content programmed for delivery into secondary unit 330 can be included and such will vary depending on the gamified game that is selected.

The content modules selected for transmission are continuously and dynamically determined throughout the entirety of the gaming experience. A particular game outcome can result in the game module sending instructions to retrieve selected files containing certain, specific display content and transmitting such content to one of more of the display devices. For instance, when a player tracked by the system scores a clean winner, the gaming parameters associated with a clean winner are received—i.e., a hit on one side of the net, trajectory of the ball across the net, no hit of the ball on the other side of the net, a second bounce of the ball, and no out of bounds conditions—resulting in selection of designated content files resulting in transmission of a graphic display exclaiming “clean winner” to one or more of the display devices. The database can be further read of data to determine the number of clean winners that were achieved by the player during the given game. The number of clean winners can then be combined with the graphic display to additionally exclaim the number of clean winners that player has achieved up to that point in the game. Additionally, accessing the historical database for that player could determine, for instance, that it is their 100^{th} clean winner. Such information can also be included in the display. This is but one example of the type of dynamic display that can occur throughout the course of game play. In another example, game scores can be intermittently displayed in accordance with specified time intervals, at the conclusion of a point, or at random throughout the course of the game. The display can be time-limited such that, after a period of time, other files are selected through the programming of the game module and another content display transmitted to the display devices. Thus, after showing the game score for a set period of time, the display can be replaced by a graphic replay of the point just played. That display can then perhaps be replaced by a display showing certain team metrics. After that, perhaps a quick advertisement or notification, and perhaps last until another trigger condition occurs, a display of the player positions for the next action.

Other dynamically determined content can include graphic displays showing game outcomes such as the positioning of where the ball landed on the court surface relative to boundary lines; if the ball hit the net; player locations to determine if they were properly located outside the kitchen area. These displays will be triggered upon occurrence or if certain parameters are met that trigger that form of content display. Furthermore, dynamic display content unique to the various gamified games will be displayed upon trigger events associated with those games.

Display content can also be randomly selected from a group of selectable content modules as opposed to being selected upon a game outcome event. Upon a pre-determined trigger event, such as a point in time, a given score, among other things, for instance a module containing an advertisement can be randomly selected from a group of modules available for selection. A game metric can be displayed from a group of different types of metrics. Alternatively, such content modules can be selected in a pre-determined order upon successive, similar trigger events.

Display content will be continuously displayed at each of the display devices throughout the duration of the gaming activity. Periodic changes in such content based will occur various trigger conditions set within the game module instructions. The trigger conditions can be related to game outcomes or otherwise. The newly transmitted content displays selected upon a trigger condition can be transmitted to any, all or some of the display devices lined and in communication with the game tracking and gamification system.

As previously indicated, the base game module within root device 320 includes the basic game fundamentals. In this embodiment, the base game fundamentals are associated with the game of pickleball. Therefore, processing unit 310 functions only to track the position and trajectory of game objects relative to the court layout and boundaries of pickleball. That data is continuously and timely delivered to root device 320 in micro time increments. The information or input received and processed through the rule-based instructions of the base game module. Therefore, did the ball first land within the boundaries of the playable court, did the ball bounce a second time, did the ball get stopped by the net, was the ball struck within the kitchen area. These are the type of basic game fundamentals so determined. The gamified game module integrated with the base game module further uses this information to establish outputs processed by the rule-based instructions of the gamified game module. Depending on the gamified game module selected and then integrated with or coupled with the base game module, the established outputs will differ.

Though the fundamental information determined through the base game module is always determined and used, the gamified game module can be seamlessly decoupled from processing unit 310. Thereafter, the rule-based instructions associated with that gamified game module will no longer be processed. A different gamified game module can then be seamlessly integrated with or coupled to the base game module according and new rule-based instructions applied using the information obtained from the base game module. There can be many of these gamified game modules developed for use with root device 310. These are all modifications to, or gamification of, the pickleball base game. Any or all of the features mentioned, above, provided through content displays at various display devices, including others envisioned for use with a particular gamified game or for all or some of the gamified games developed for use and available within root device 310 can be made available through the programmed instructions of the gamified game modules. Example embodiments of a couple of gamified games will now be described.

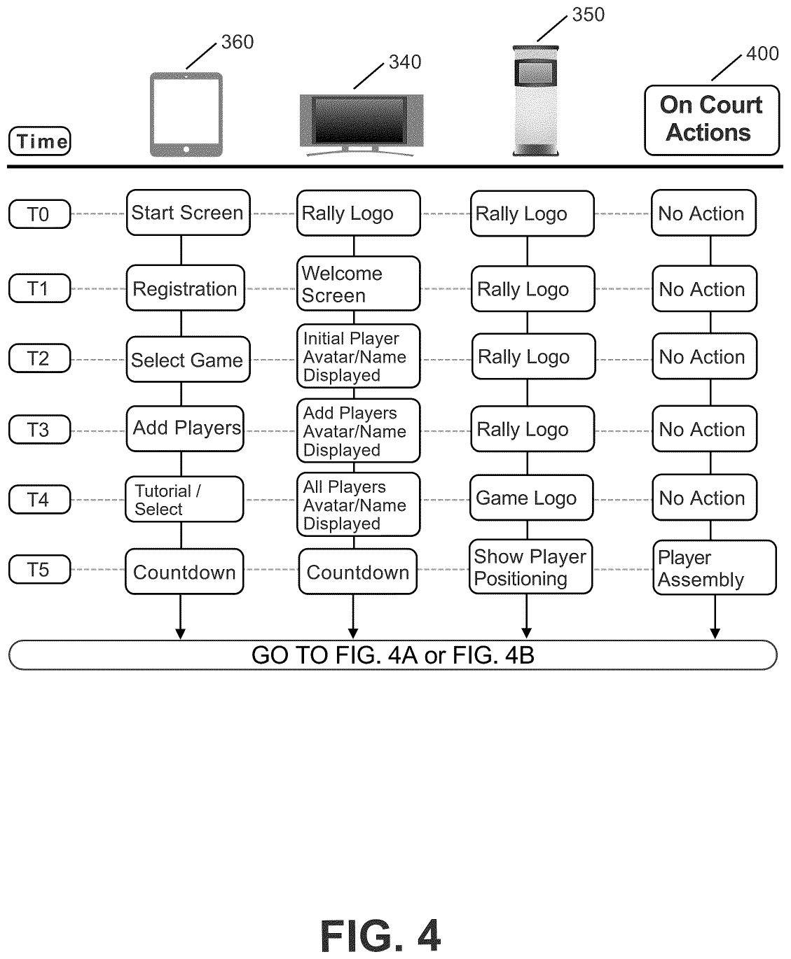

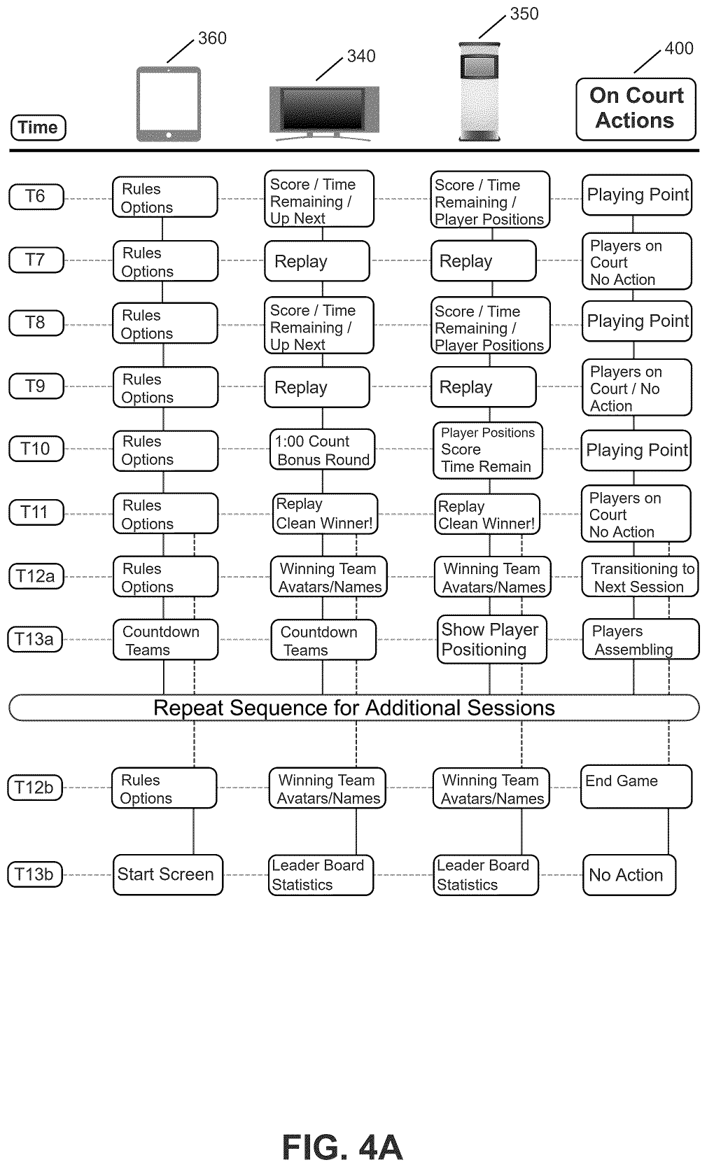

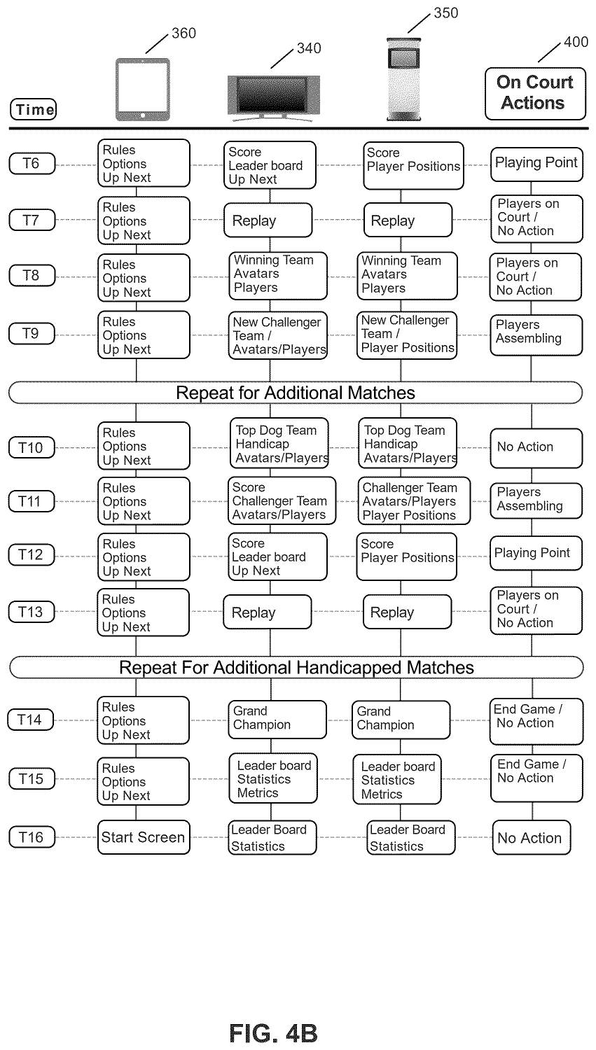

Referring to FIG. 4, a schematic diagram depicts a time dependent series of events and associated displays at various display screens. Six distinct time periods are shown beginning at “T0” and ending at “T5”. There are three devices; monitor 340, kiosk 350, and tablet 360 each having a display screen, each associated with each of the distinct time periods. Additional devices, including personal computers and mobile devices of registered users who have actively selected to be associated with the given game activity, can be included but for simplicity are not shown. A column of actions depicting “On Court Action” 400; i.e., what is occurring at each distinct time period on the pickleball court, is also shown. FIG. 4 depicts an example embodiment only of the player registration process and thus the initial actions involving the game tracking and gamification system. These aspects would be relatively similar regardless of the gamified game selected and are prior to any gaming activity.

At T0, the system is stagnant or in a state of rest. There is no action from the court, there are no players and nobody has yet registered for play. If the system is powered on and available for use, a start screen is displayed on tablet 360 and the system logos are displayed on monitor 340 and kiosk 350 display screens. The start screen may include a number of options including registration as a new player or registration as a returning player. The first option might include entering identification information, payment information and skill level, among other things. The second option might include the input of a username and password or personal identification number. At T1, the player registers with the system. New registrants are presented with the requirement or option to select a handle or name and/or an avatar for display when certain content modules are selected for display that would include players handles and avatars within the graphic display. During the input of data at tablet 360, the system logo is displayed at kiosk 350 while a welcome screen is displayed at monitor 340 to provide a welcome and information to those viewing the monitor, as per the instructions originating from root device 310 and delivered to secondary unit 330, which then transmits the applicable content to monitor 340. Alternatively, another device having input capabilities and linked to the system through ISP link 370 may be used for input of registration data and all other input data provided to and used by the system. Once the player or registrant is registered or identified by the system, at T2 the player is given the option to select from a series gamified games identified by names. The gamified game selected would then be seamlessly integrated with or coupled to the base game module to provide the gamification features particular to that selected gamified game. At monitor 340 the player's handle and avatar is displayed indicating that they will be next up for play on the indicated court. The system logo remains displayed at kiosk 350. Throughout this process and up to this point, there remains no on court activity although the gamified game module is now associated with the game tracking and gamification system and ready for processing therewith. The newly selected gamified game will receive position and trajectory data from processing unit 310 and based game module to carry out the instructions in accordance with the rules of the gamified game module of the selected gamified game. At T3, players are added through data input on tablet 360 or other ISP linked device, such as the players personal computer or mobile device, through the app. For any of the initial registering player or later added players, either the tablet or any device embodying the app and linked with the system can be used for providing input. As with registration at T1, the added player or players will enter the necessary information according to whether they are new registrants to the system or returning players. The added player or players are also displayed by handle and avatar on monitor 340 in accordance with the handle and avatar they selected. At T4, once all of the players are added that intend to play (generally, two players if a game involving single play and four players if doubles), all such players' handles and avatars are displayed on monitor 340. However, at this point, the root device having received a signal that all players have registered that intend to register, a game logo depicting the gamified game selected is displayed on kiosk 350 replacing the system logo. Not shown, but of potential display, at this after all players are shown by handle and avatar for a set period of time, an advertisement might be triggered for display. Additionally, certain game metrics and statistics associated with each of the players may be pulled from stored data in the system database for display. T4, the point at which all players that intend to play the gamified games have completed registration, could be a trigger point for the display of any type of timed content display at one or more of the associated display devices. In this embodiment, tablet 360 now displays or allows for selection of a tutorial showing the rules of play of the selected gamified game. T5 is when courtside activity is set to begin. The players are shown to be assembling. Kiosk 350 graphically displays where each individual player is to be positioned. A countdown clock, not shown, can also be indicated to show the start of game action. Tablet 360 and monitor 340 display a countdown to the start of the game and a message that players should “head to court”. The handles and avatars of the players are displayed in accordance with their respective identities.

In the present embodiment, there are three selectable gamified games—Matchplay Shuffle, Top Dog, and Standard Dubs. Matchplay Shuffle is a multi-round gamified game of pickleball that focuses on individual efficiency. The game tracking and gamification system aims to pair each player with every other player. Top Dog is also a team-based gamified game of pickleball with multiple rounds. Each team competes to outperform the others. Standard Dubs allows the system to select players for a single-round game. The user interface accessed upon registration includes modules that guide players through the rules of each of the selectable gamified games and helps organize who joins the game and who will be on which team, among other things. The time dependent actions and content displays of the system will differ according to which of the gamified games is selected and the rule-based instructions of such game.

Referring to FIG. 4A, this schematic picks up system sequencing after selection of the gamified game Matchplay Shuffle. This gamified game provides for a series of six-minute sessions. Therefore, the gamified game module remains active and continuous from initial selection of the gamified game until the conclusion of game activity. It includes a series of gaming features that gamifies the game of pickleball. The features are consistently applied for the duration of gaming activity. The features are ever-present and do not appear as a one-off event or a series of one-off events but as an enduring, constant that provides some ongoing features (i.e., content deliveries) based on game outcomes or other trigger based conditions.

At T6, during active play, tablet 360 reverts to a selection that provides certain options. One could withdraw from the game, change the game and or challenge the last point. If the latter, the point can be replayed or awarded to the other team or player. Monitor 340 and kiosk 350 display a scoreboard and a time remaining countdown clock. Monitor 340 also displays the team or player that is up next while kiosk 350 displays player positions. The system tracks the individual players, whose identifications are tagged, through IP cameras 106a-106d and processing unit 310 and tracks and displays their locations on screen. The position at initiation of play, which was system assigned or input by the players, is used to enable individual tracking. In tracking individual players and teams, individual and team stats and metrics are determined. Leaderboards are established to display individual and team stats and metrics such as most nets, longest rally, average rally, most points scored, most clean winners, along with any other statistics or metrics as determined by logic within root device 320. Any of this information can be transmitted in the form of a graphic display to any of the associated display screens at any T point or between T points in a timed manner and in accordance with the pre-programmed instructions of the game module.

At T7, after the play for the point has ended, a short duration replay is shown at both the monitor and kiosk. The sequence of events repeats for each point played (as shown at T8 and T9). When one minute remains, a countdown clock is indicated at T10. Per the game rules of Matchplay Shuffle, during this period double points are awarded for clean winners. Upon achieving such, the monitor and kiosk exclaim the message “Clean Winner!” at T11 along with a short duration replay of the event. Two points are applied to the team that achieved the clear winner and the scoreboard is updated to reflect. A graphic message could additionally be included at T10 indicating that during the one minute countdown, that double points are provided during this period for clean winners.

At T12a new teams of players are transitioning to play the next six-minute session. While this is occurring, the avatars and handles of the winning team are displayed at the monitor and kiosk. At T13a, the countdown to start the next session begins anew. This is shown at the tablet 360 and monitor 340 along with a showing of the new teams and players. Kiosk 350 once again displays the system assigned positioning of the new players, which will be used once again to track individual players during game play and to accumulate individual and team success metrics for later display upon leaderboards and other content forms. The system also recognizes the order of play thereby assigning positions to the identified players during the next point play. The sequence of sessions is repeated until, at some point after a predetermined number of sessions or until all teams have played every other team, the game will end. At that point, instead of transitioning to the next session, as indicated at T12a, the game will end at T12b. The winning teams are displayed at monitor and kiosk along with their handles and avatars. A congratulatory graphic display may be made to accompany the identification of the winning teams. After a predetermined period of time tablet 360 reverts back to the start screen at T13b, which displays the pre-game registration content. A leaderboard is displayed at the monitor 340 and kiosk 350 which includes various statistics and metrics associated with the selected gamified game that was tracked during the previous gamified game sessions. Game data stored in memory from previously played game sessions that is associated with the present teams and individuals may be read and combined with the just-played session data to further display historical statistics and metrics.

This is an example embodiment of the content that may be directed for display at the various display screens based on a sequence of events associated with the selected gamified game. The selected gamified game caused the gamified game module to link with the base game module. The selected gamified game module established the game rules for that selected gamified game, including the scoring methodology, and the displays that would occur with each game outcome or as determined by any other trigger event, and at what display screen the content displays would be displayed. Use of the raw data received from processing unit 310 to determine the position of game objects and determine trajectories is used and applied in accordance with the game rules of the selected gamified game—Matchplay Shuffle in this instance. Additionally, to emphasize the point, it should be appreciated that the content modules described above are not limiting. Multiple other content modules can be directed to any or all of the displays. Leaderboards, metrics, statistics can be delivered at any time in combination with other content or alone. An individual or team event, such as a players first clean winner, or their 100^{th} clean winner, or the achievement of a milestone or goal, a player's birthday, can be determined within the system and transmitted to the directed to one, some or all of the display devices based on the occurrence of such and on a given trigger condition. All manner of content can be included to create a fun and exciting gamified gaming experience.

FIG. 4B is another embodiment showing a gamified game event sequence for the selected gamified game referred to as Top Dog. The Top Dog game is selected and the gamified game module associated with it is integrated with, or coupled to, the base game module. The rules of play, content displays, scoring methodology, scoreboards, and the event sequencing of Top Dog will be controlled through instructions of the Top Dog gamified game module. This is a gamified game generally played among large groups.

The sequence of events is similar to Matchplay Shuffle in certain respects. The same rules and options screen may be displayed on tablet 360 although a tutorial, if individually provided and not selectable, will be provided for Top Dog since this is the actively selected gamified game. During play, a scoreboard is displayed at both monitor 340 and kiosk 350. A leaderboard can be intermittently shown as can the team that is “up next”. Between points, a short duration replay of the previously played point may be shown. It could be an animated replay, the system knowing from its tagging and tracking of the individual players which player is which, and avatars depicting such players may be used to display the prior action. Alternatively, the system may retrieve prior streaming imagery that was taken from the court IP cameras and segment a portion of the video for display at monitor 340 and kiosk 350. There could further be provided an animated graphic content showing a reaction to the prior play. It can be any content designed and instructed for transmission to the monitor and kiosk during the given time event sequence. This sequencing takes place at T6 and T7 and repeats continuously until one team or the other achieves four points. Similar to MatchPlay Shuffle, any additional content modules can be transmitted to the associated display devices at any T point or between T points in accordance with various trigger conditions and in accordance with the timed duration for such display as provided by the gamified game module pre-programmed instructions.

At T8, the winning team for the given match is determined and a new challenging team is entered. The player handles and avatars are sent to both the monitor and kiosk for display while the players assemble on court. The “up next” indication on the tablet device displays yet another team waiting to play the winner of the soon to be played and pending match. The sequence of events cycles generally between T6 and T9 unless and until a team—the winner or championship team—has won three matches in a row or the entire gamified game has ended. At that point, as shown at T10, a graphical indication is made at monitor and kiosk that a handicap is to be applied to the thrice-in-a-row winning team. At this point, the team has attained “Top Dog” status. Instructions may exist within the game module to also send a signal to secondary unit 330 to deliver a content module that provides an animated display of the Top Dog achievement to monitor 340 and kiosk 350. With the handicap, the challenger team need only score three points to win prior to the Top Dog team scoring five points. At T11, the challenger team is indicated at both monitor and kiosk. The monitor further displays the handles and avatars of the new challenging team while the kiosk displays player positions. T12 and T13 perform similar to that of T6 and T7 though the system will end the match should the challenger team achieve three points. At that point, the game will pick up at T8 and continue until the conclusion of the game or another team achieves Top Dog status, in which case, the sequence will move to T10, once again. At the conclusion of the game, the team with the most wins is displayed as “Grand Champion” (T14) along with other graphical indications. Leaderboards, game statistics, game metrics and other indicia may be displayed thereafter or in addition (T15). After completion of game activity T16, tablet 360 will revert back to the start screen for selection of a new gamified game by a player, and registration of additional players for play. Logos, leaderboards or other metrics may remain on kiosk and monitor.

As with Matchplay Shuffle, the above description of the sequence of events and the different graphics and information delivered to the various video display screens associated with the game tracking and gamification system is merely exemplative. Any sequence established by programming of the gamified game module can be provided subject to synchronicity with the rules of play; any form of content can be created and delivered; any triggers can be established to deliver such specific content to the various display devices, and directed delivery can be provided to all, one or some of the display devices associated with the system. When the game is selected, be it Matchplay Shuffle, Top Dog, Standard Dubs, or any other established game, the selected gamified game module is integrated with, or coupled to, the base game programming that is associated with the fundamental rules of the game of pickleball and causes the system to process that applicable computer code and react, accordingly. The standard rules of play inherent in the base game module will always remain and the selected gamified game merely utilizes such to enable its own rules of play to be carried out. Therefore, position and trajectory data received enabling the base game module to determine if a ball was inside or outside the boundary lines of the court, if the ball hit the net and did not carry over to the other side of the court, if the ball bounced more than once, if the ball did not bounce once, which is required in the base game of pickleball during the first volley, if a player was in the kitchen when striking the ball, which is not permitted in the game of pickleball, and myriad other decisions based on player and ball in association with court boundaries, the net and the basic rules of play. With the gamified game module, these inputs and decisions processed based on such are factored into the rules of play for the gamified game and the outputs derived and the sequence of events conducted, accordingly.

It should be understood that the foregoing relates primarily to preferred embodiments of the invention but is not limited to such, and that modifications and variations may be made without departing from the spirit and scope of the invention as set forth in the following claims. While specific embodiments and examples are described herein for illustrative purposes, various modifications are possible that would be considered within the scope of such embodiments and examples, as those skilled in the relevant art would recognize.

In this regard, while the subject matter has been described herein in connection with various embodiments, it should be understood that other similar embodiments can be used or modifications and additions can be made to the described embodiments for performing the same, similar or alternative functions without deviating from the general subject matter described. Therefore, the disclosed subject matter should not be limited to any single embodiment described herein, but rather should be construed in breadth and scope in accordance with the claims made.

What is claimed is:

1. A game tracking and gamification system for a court-based game, the system comprising:
a plurality of networked video recording cameras statically positioned about the court at different locations for video streaming the play of the court-based game;
at least one player, one active game element and one static game element associated with the court-based game;
at least one memory storage device for storing positional location of the at least one static game element, the positional location established during setup of the tracking, scoring and gamification system through digital framing by the plurality of video recording cameras;
a processing unit having at least one processor for receiving and analyzing said video streams to extract real time location data associated with the at least one active game element of the court-based game using similarly time-stamped digital frames produced by the plurality of video recording cameras and the application of algorithms stored in said at least one memory storage device for calculating the trajectory of the at least one active game element;
a base game module stored in said at least one memory storage device including a game outcome determination module for determining through the at least one processor a plurality of outcomes associated with said court-based game using the location data of the at least one active game element and the positional location of the at least one static game element wherein said plurality of outcomes are assessed against a set of game rules contained in said base game module to provide game results associated with said set of game rules;
a gamified game module activated through an interface on a computer device communicatively connected to said system to interface with said base game module to modify said set of game rules, wherein said game results associated with the base game module are modified to game results associated with said gamified game module and said modified set of game rules.

2. The system of claim 1 further comprising:
a plurality of display devices communicatively linked to the base game module and gamified game module;
a plurality of content modules stored in said memory storage device;
a plurality of conditions associated with said modified set of game rules wherein upon the occurrence of one of said plurality of modified game results one of said conditions from said plurality of conditions associated with said modified set of game rules causes at least one of said plurality of display devices to receive a designated one of said plurality of stored content modules for display.

3. The system of claim 2, wherein at least two of said plurality of display devices each receive a designated one of said plurality of stored content modules for display and wherein each said content modules is distinctly different in content.

4. The system of claim 2, wherein said plurality of conditions include at least one outcome from said plurality of outcomes such that upon the occurrence of said outcome, one of the conditions from said plurality of conditions associated with said outcome causes at least one of said plurality of display devices to receive a designated one of said plurality of stored content modules for display.

5. The system of claim 2, wherein said plurality of conditions include at least one condition is unrelated to any of said plurality of outcomes.

6. The system of claim 2, wherein throughout the duration of said court-based game at least some of said conditions from said plurality of conditions are continuously met resulting in at least some of said content modules from said plurality of content modules being continuously received for display by at least one of said display devices from said plurality of devices.

7. The system of claim 1 further comprising:
a plurality of gamified game modules, wherein said player selects one of said plurality of gamified game modules through said interface on one of said display devices from said plurality of display devices.

8. The system of claim 1, wherein the court-based game is a field-based game.

9. A gamification system for a court-based game, the system comprising:
a game tracking system for determining time-dependent positioning data of game objects;
a computer processor;
an outcome determination module communicatively connected to said game tracking system to receive and process through said computer processor said positioning data to determine in association with computer-based instructions of said outcome determination module outcome data associated with fundamental contours of the court-based game;
a gamified game module communicatively linked to said outcome determination module for applying said outcome data to distinct rules of play of a gamified game associated with said gamified game module to obtain a plurality of game results, wherein said gamified game module is one of a plurality of gamified game modules and said gamified game module is communicatively connected to said outcome determination module through selection of said gamified game module from a plurality of gamified game modules listed within a user interface of a computer device communicatively coupled to said system.

10. The system of claim 9 further comprising:
a plurality of display devices communicatively coupled to the gamified game module selected from the plurality of gamified game modules;
a plurality of content modules associated with said gamified game module stored in a memory storage device, each of said plurality of content modules having distinct content;
a plurality of conditions associated with said game results wherein upon the occurrence of one of said plurality of game results one of the conditions from said plurality of conditions that is associated with said game result causes said gamified game module to send to at least one of said plurality of display devices a designated one of said plurality of stored content modules for display.

11. The system of claim 10, wherein at least two of said plurality of display devices each receive a designated one of said plurality of stored content modules for display upon one of said plurality of conditions.

12. The system of claim 10, wherein said plurality of conditions are associated with said outcome data so that upon the occurrence of a designated outcome data, one of the conditions from said plurality of conditions associated with said designated outcome data causes at least one of said plurality of display devices to receive a designated one of said plurality of stored content modules for display.

13. The system of claim 9 wherein the court-based game is a field-based game.

14. The system of claim 9, wherein said gamified game module selected from said plurality of gamified game modules remains communicatively linked to the outcome determination module to provide gamification effects and features for the entirety of the court-based game.
